(19) United States
(12) Patent Application Publication
(10) Pub. No.: US 2025/0192660 A1
(43) Pub. Date: Jun. 12, 2025

(54) POWER CONVERTER

(71) Applicant: FUJI ELECTRIC CO., LTD., Kawasaki-shi (JP)

(72) Inventors: Hirofumi UEMURA, Tokyo (JP); Sachio TAKANO, Tokyo (JP)

(73) Assignee: FUJI ELECTRIC CO., LTD., Kawasaki-shi (JP)

(21) Appl. No.: 19/063,061

(22) Filed: Feb. 25, 2025

Related U.S. Application Data
(63) Continuation of application No. PCT/JP2024/007091, filed on Feb. 27, 2024.

(30) Foreign Application Priority Data
Mar. 1, 2023 (JP) 2023-031375

(51) Int. Cl. H02M 1/00; H02M 1/32; H02M 7/539

(52) U.S. Cl. CPC H02M 1/0038; H02M 1/0016; H02M 1/325; H02M 7/539

(57) ABSTRACT

A power converter having a power conversion circuit, a filter provided and a control device configured to control an output voltage of the power conversion circuit to a power system. The control device includes: a voltage amplitude command calculation unit configured to calculate an amplitude command value for the output voltage; a frequency command calculation unit configured to calculate a frequency command value for the output voltage; a current command calculation unit configured to calculate a first current command value for the output current; and a voltage command calculation unit configured to generate a command value for the output voltage. The current command calculation unit, responsive to a magnitude of the first current command value exceeding an upper limit value, calculates a second current command value as the current command value, by restricting the magnitude of the first current command value to the upper limit value.

### CROSS-REFERENCE TO RELATED APPLICATIONS

This is a continuation application of International Patent Application No. PCT/JP2024/007091 filed Feb. 27, 2024, which claims the benefit of priority to Japanese Patent Application No.2023-031375 filed Mar. 1, 2023, the entire contents of each of which the entire contents of each of which are incorporated herein by reference.

### BACKGROUND

### Technical Field

The present disclosure relates to a power converter.

### Description of the Related Art

Virtual synchronous generator control in which a power converter connected to a power system is operated as a virtual synchronous generator is known (for example, Japanese Patent No. 7183486).

In a virtual synchronous generator described in Japanese Patent No. 7183486, countermeasures against occurrence of an overload, a short-circuit fault, and the like in a power system are not disclosed.

The present disclosure is directed to provision of a power converter capable of continuing to operate even in the event of occurrence of an accident in a power system.

### SUMMARY

An aspect of the present disclosure is a power converter that is interconnected with a power system to operate as a virtual synchronous generator, the power converter including: a power conversion circuit; a filter provided between the power system and the power conversion circuit; and a control device configured to control an output voltage outputted from the power conversion circuit to the power system, the control device including: a voltage amplitude command calculation unit configured to calculate an amplitude command value for the output voltage; a frequency command calculation unit configured to calculate a first frequency command value, based on a rated frequency of the power system, and to set the first frequency command value as a frequency command value for the output voltage; a current command calculation unit configured to calculate a first current command value, based on the amplitude command value for the output voltage, the frequency command value for the output voltage, the output voltage, and an output current that is outputted to the power system, and to set the first current command value as a current command value for the output current; and a voltage command calculation unit configured to generate a command value for the output voltage, based on the current command value for the output current, a filter current having flowed in the filter, and the output voltage, wherein the current command calculation unit is configured to, responsive to a magnitude of the first current command value exceeding an upper limit value, calculate a second current command value by restricting the magnitude of the first current command value to the upper limit value, and to set the second current command value as the current command value for the output current.

Other features of the disclosure are made clear by the present description.

According to the present disclosure, it is possible to provide a power converter capable of suppressing overcurrent.

### BRIEF DESCRIPTION OF DRAWINGS

FIG. 1 is a diagram illustrating an example of a power system 1 provided with a power converter 2 of an embodiment.

FIG. 2 is a diagram illustrating an example of a power system 1 provided with a power converter 2.

FIG. 3 is a diagram illustrating a frequency command calculation unit 22 of the power converter 2.

FIG. 4 is a diagram illustrating a voltage amplitude command calculation unit 23 of the power converter 2.

FIG. 5 is a diagram illustrating an instantaneous current command calculation unit 25 of the power converter 2.

FIG. 6 is a diagram illustrating a compensation value output unit 26 of the power converter 2.

FIG. 7 is a diagram illustrating an instantaneous voltage command calculation unit 28 of the power converter 2.

FIGS. 8A to 8H are diagrams illustrating simulation results.

FIGS. 9A to 9H are diagrams illustrating simulation results.

FIGS. 10A to 10H are diagrams illustrating simulation results.

### DETAILED DESCRIPTION

### First Embodiment

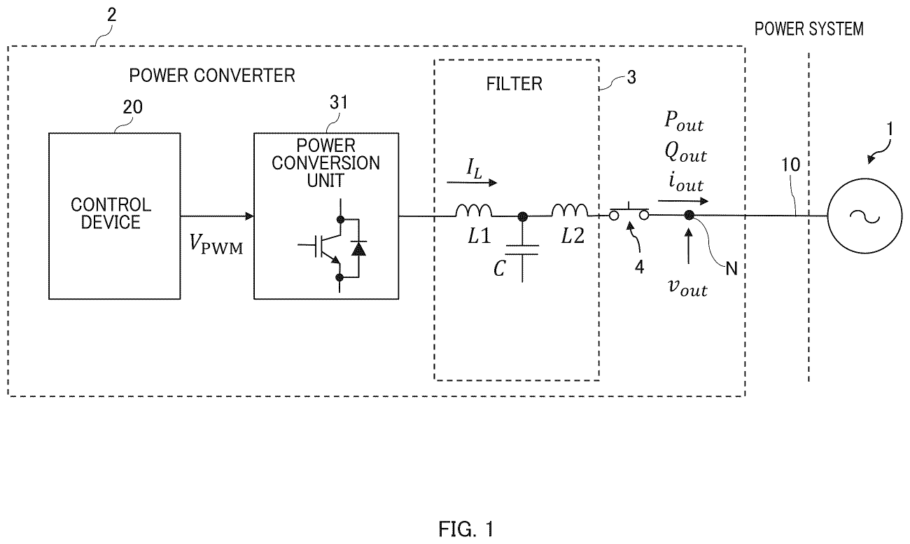

FIG. 1 is a diagram illustrating a power converter 2 of the present embodiment that is interconnected with a power system 1. The power system 1 is a power system that supplies AC power generated in a power plant to a consumer facility via a distribution line 10.

The power converter 2 is a device that inputs/outputs power to/from the power system 1, and operates as a virtual synchronous generator. The power converter 2 includes a filter 3, a switch 4, a control device 20, and a power conversion unit 31. The power conversion unit 31 of the power converter 2 is connected to the power system 1 via the filter 3 and the switch 4.

### <<Filter 3>>

The filter 3 (corresponding to a “filter unit”) is provided in order to remove a harmonic component of a current flowing from the power converter 2 to the power system 1. A current I_{L} outputted from the power converter 2 is inputted to the filter 3. The filter 3 outputs, to the power system 1, a current iₒᵤₜ obtained by removing a harmonic component from the current i_{L}.

The filter 3 includes a reactor L1, a reactor L2, and a capacitor C. The reactor L1 and the reactor L2 are connected to each other in series. The reactor L1 is connected to an output of the power converter 2, and the reactor L2 is connected to the power system 1.

One end of the capacitor C is connected between the reactor L1 and the reactor L2. The other end of the capacitor C is connected to a three-phase neutral point (not illustrated). The other end of the capacitor C may be grounded.

### <<Switch 4>>

The switch 4 is connected between the power system 1 and the power converter 2. The switch 4 is a circuit breaker, for example.

When the power system 1 is in a normal state, the switch 4 is ON, and the power converter 2 can exchange power with the power system 1. When an abnormality such as a failure in the power system 1 occurs, the switch 4 is switched to OFF, and the power converter 2 is disconnected from the power system 1.

### <<Power Converter 2>>

The power converter 2 is a device that operates as a virtual synchronous generator using a voltage control (Grid-ForMing (GFM)) scheme.

Specifically, the power converter 2 is a device that controls a frequency fₒᵤₜ of an output voltage vₒᵤₜ to output active power Pₒᵤₜ between the filter 3 and the power system 1. The active power Pₒᵤₜ being positive is active power outputted from the power converter 2 to the power system 1. The active power Pₒᵤₜ being negative is active power inputted from the power system 1 to the power converter 2.

### <Control Device 20>

Functional Block of Control Device 20

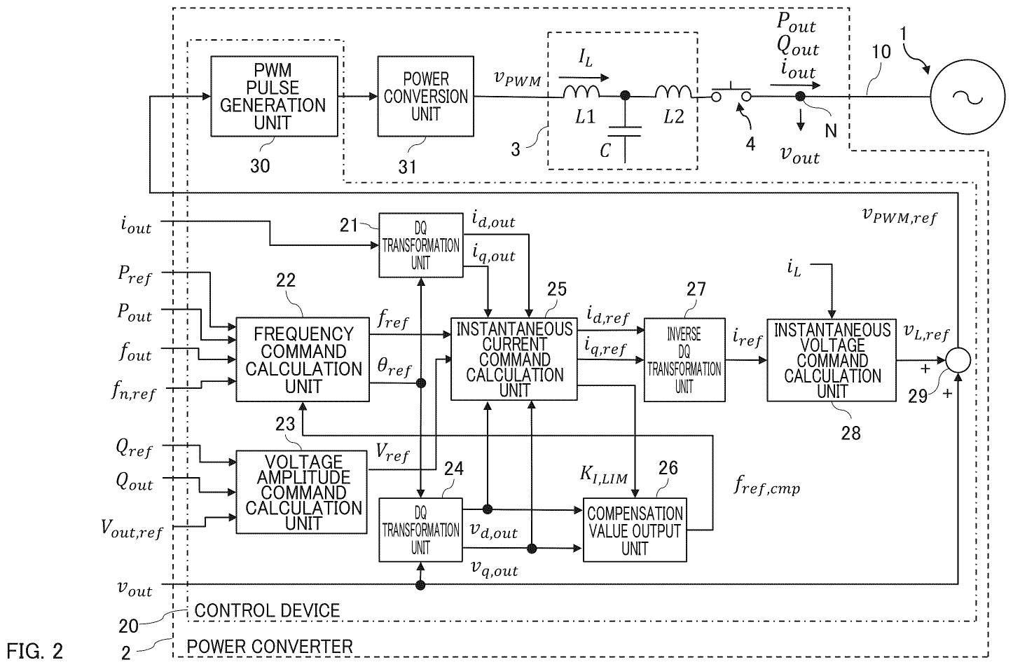

FIG. 2 is a diagram illustrating the power converter 2, particularly illustrating the functional blocks (software building blocks) of the control device 20.

The control device 20 includes dq transformation units 21 and 24, a frequency command calculation unit 22, a voltage amplitude command calculation unit 23, an instantaneous current command calculation unit 25, an inverse dq transformation unit 27, a compensation value output unit 26, an inverse dq transformation unit 27, an instantaneous voltage command calculation unit 28, an addition unit 29, and a PWM pulse generation unit 30.

### [dq Transformation Unit 21]

The dq transformation unit 21 (corresponding to a “first dq transformation unit”) performs dq transformation on an output current iₒᵤₜ of each of three phases outputted to the power system 1, and outputs a d-axis current i_{d,out} and a q-axis current i_{q,out} (FIG. 2).

The d-axis current i_{d,out} and the q-axis i_{q,out} are a d-axis component and a q-axis component in a rotating coordinate system that rotates at an angular frequency corresponding to a system frequency of the power system 1, respectively.

### [Frequency Command Calculation Unit 22]

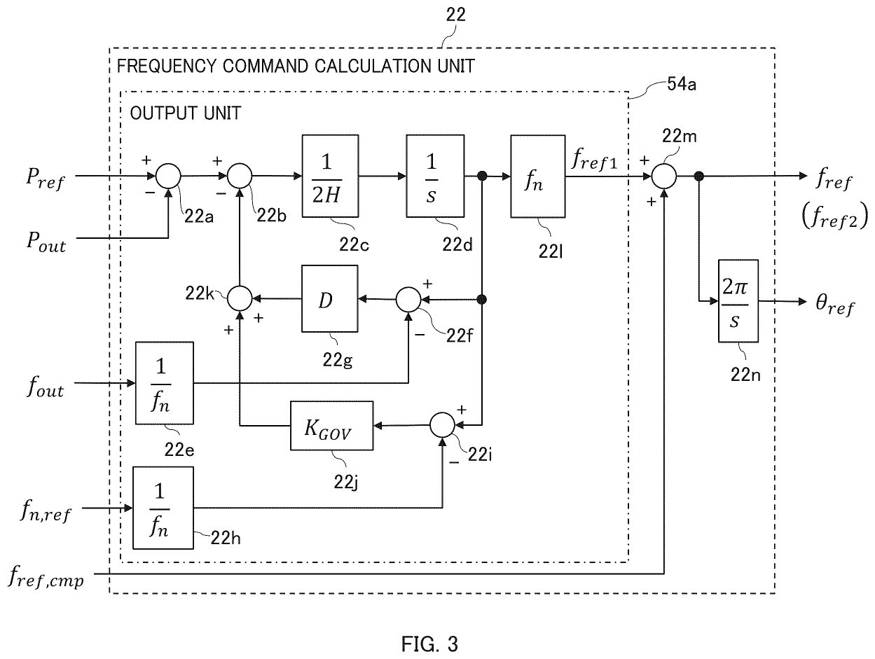

FIG. 3 is a diagram illustrating the frequency command calculation unit 22 of the power converter 2. The frequency command calculation unit 22 outputs, based on a rated frequency fₙ of the power system 1, a frequency command value f_{ref} (corresponding to a “first frequency command value”) and a phase command value θ_{ref} for a voltage outputted from the power conversion unit 31 (which will be described later).

Specifically, the frequency command calculation unit 22 calculates the command frequency command value f_{ref} and the phase command value θ_{ref}, based on an active power command P_{ref} being a command value for active power outputted to the power system 1, active power Pₒᵤₜ actually outputted to the power system 1, and a predetermined set frequency f_{n,ref}.

The active power Pₒᵤₜ is a measured value at a node N between the filter 3 and the power system 1, as illustrated in FIG. 2. Reactive power Qₒᵤₜ, an output voltage vₒᵤₜ, and an output current iₒᵤₜ, which will be described later, are also measured values at the node N.

In the following description, “H” refers to an inertia constant and “D” refers to a damping constant, when the power converter 2 operates as the virtual synchronous generator.

As illustrated in FIG. 3, the frequency command calculation unit 22 includes adders 22a, 22b, 22f, 22i, and 22k, multipliers 22c, 22e, 22g, 22h, 22j, 22l, and 22l, and integrators 22d and 22n.

The adder 22a outputs, to the adder 22b, a value obtained by subtracting the active power Pₒᵤₜ from the active power command P_{ref} (P_{ref}−Pₒᵤₜ).

The adder 22b outputs, to the multiplier 22c, a value obtained by subtracting an input from the adder 22k (which will be described later) from an inputted value (P_{ref}−Pₒᵤₜ) from the adder 22a.

The multiplier 22c outputs, to the integrator 22d, a value obtained by multiplying the input from the adder 22b by 1/(2H) (where H is the inertia constant).

The integrator 22d outputs, to the multiplier 22l, a result of time integration of the input from the multiplier 22c over a predetermined time period.

The value obtained here by the integration operation is a value obtained by normalizing the frequency command value f_{ref} for the output voltage vₒᵤₜ outputted to the power system 1 by the rated frequency fₙ of the power system 1. For example, in Japan, the rated frequency fₙ of the power system 1 is 50 Hz in eastern Japan and is 60 Hz in western Japan.

The multiplier 22e outputs, to the adder 22f, a value obtained by dividing a frequency fₒᵤₜ of the output voltage vₒᵤₜ by the rated frequency fₙ of the power system 1. The outputted value from the multiplier 22e is a value obtained by normalizing the frequency fₒᵤₜ of the output voltage vₒᵤₜ by the rated frequency fₙ.

The adder 22f outputs, to the multiplier 22g, a value obtained by subtracting the input from the multiplier 22e from the input from the integrator 22d.

The multiplier 22g outputs, to the adder 22k, a value obtained by multiplying the input from the adder 22f by the damping constant D.

The multiplier 22h outputs, to the adder 22i, a value obtained by dividing the set frequency f_{n,ref} by the rated frequency fₙ of the power system 1. The outputted value from the multiplier 22h is a value obtained by normalizing the set frequency f_{n,ref} by the rated frequency fₙ.

The adder 22i outputs, to the multiplier 22j, a value obtained by subtracting the input from the multiplier 22h from the input from the integrator 22d.

The multiplier 22j outputs, to the adder 22k, a value obtained by multiplying the input from the adder 22i by a gain K_{GOV}. Here, the gain K_{GOV} is a parameter for adjusting a rotational speed of a rotor to be kept at the set frequency f_{n,ref}.

The adder 22k outputs, to the adder 22b, a value obtained by adding the input from the multiplier 22g to the input from the multiplier 22j.

The multiplier 22l outputs a value obtained by multiplying the input from the integrator 22d by the rated frequency fₙ of the power system 1. The outputted value from the multiplier 22l is a frequency command value f_{ref1} before compensation of the output voltage vₒᵤₜ outputted to the power system 1.

The adder 22m (corresponding to a “second addition unit”) outputs, as a frequency command value f_{ref2} after compensation, a value obtained by adding an after-mentioned compensation value f_{ref,cmp} to the frequency command value f_{ref1} before compensation.

The integrator 22n multiplies the input from the adder 22m by 2n and calculates time integration of the resultant value over a predetermined time period. With such a calculation, the integrator 22n outputs the phase command value θ_{ref} that is a command value for a phase of the output voltage vₒᵤₜ outputted from the power converter 2.

### [Voltage Amplitude Command Calculation Unit 23]

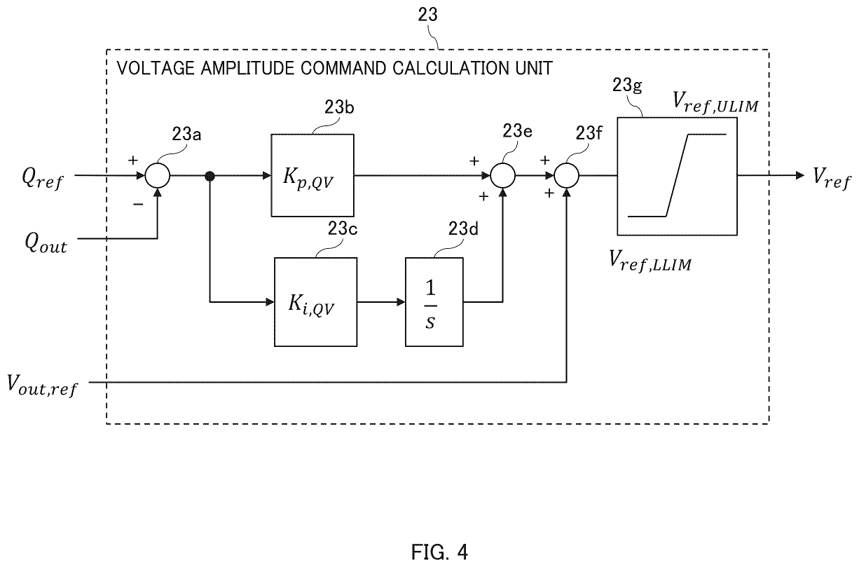

FIG. 4 is a diagram illustrating the voltage amplitude command calculation unit 23 of the power converter 2. The voltage amplitude command calculation unit 23 calculates an amplitude command value V_{ref} for the voltage outputted from the power converter 2.

Specifically, the voltage amplitude command calculation unit 23 calculates the amplitude command value V_{ref}, based on a reactive power command Q_{ref} as a target to be outputted to the power system 1, reactive power Qₒᵤₜ actually outputted to the power system 1, and an amplitude command value V_{out,ref} for the output voltage vₒᵤₜ.

The voltage amplitude command calculation unit 23 includes adders 23a, 23e, and 23f, multipliers 23b and 23c, an integrator 23d, and a restriction unit 23g.

The adder 23a outputs, to the multiplier 23b and the multiplier 23c, a value obtained by subtracting the reactive power Qₒᵤₜ from the reactive power command Q_{ref}.

The multiplier 23b outputs, to the adder 23e, a value obtained by multiplying the input from the adder 23a by a gain K_{p,QV}. The gain K_{p,QV} is a parameter for performing proportional control so as to suppress a difference between the reactive power Qₒᵤₜ and the reactive power command Q_{ref}.

The multiplier 23c outputs, to the adder 23e, a value obtained by multiplying the input from the adder 23a by a gain K_{i,QV}. The gain K_{i,QV} is a parameter for performing integral control so as to suppress a difference between the reactive power Qₒᵤₜ and the reactive power command Q_{ref}.

The integrator 23d outputs, to the adder 23e, a result of time integration of the input from the multiplier 23c over a predetermined time period.

The adder 23e outputs, to the adder 23f, a value obtained by adding the input from the multiplier 23b and the input from the integrator 23d.

The adder 23f outputs, to the restriction unit 23g, a value obtained by adding the input from the adder 23e and the amplitude value command value V_{out,ref} for the output voltage vₒᵤₜ.

The restriction unit 23g outputs, as the voltage amplitude command value V_{ref}, a value obtained by restricting the input value from the adder 23f, based on an upper limit value and a lower limit value that have been set.

When the inputted value from the adder 23f is equal to or greater than a lower limit value V_{ref,LLIM} and is equal to or less than an upper limit value V_{ref,ULIM}, the restriction unit 23g outputs the inputted value from the adder 23f without change.

When the inputted value from the adder 23f is greater than the upper limit value V_{ref,ULIM}, the restriction unit 23g outputs the upper limit value V_{ref,ULIM}. When the inputted value from the adder 23f is less than the lower limit value V_{ref,LLIM}, the restriction unit 23g outputs the lower limit value V_{ref,LLIM}.

Note that restriction units 24a, 24e, 52b, and 52r which will be described later are also assumed to execute the same processing as that of the restriction unit 23g to restrict inputted values, based on the upper limit value and the lower limit value that have been set.

### [dq Transformation Unit 24]

A dq transformation unit 24 (corresponding to a “second dq transformation unit”) of FIG. 2 performs dq transformation on the three-phase output voltage vₒᵤₜ outputted to the power system 1, and outputs a d-axis voltage v_{d,out} and a q-axis voltage v_{q,out}.

### [Instantaneous Current Command Calculation Unit 25}

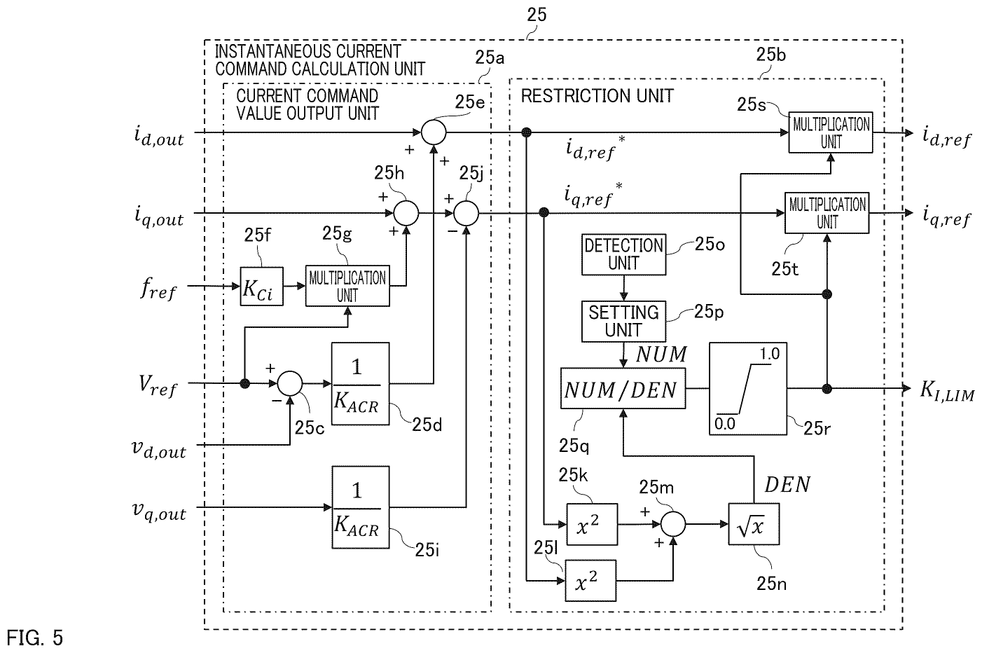

FIG. 5 is a diagram illustrating the instantaneous current command calculation unit 25 (corresponding to a “current command calculation unit”) of the power converter 2. The instantaneous current command calculation unit 25 calculates a d-axis current command value i_{d,ref} and a q-axis current command value i_{q,ref} (corresponding to a “first current command value”), based on the d-axis current i_{d,out} and the q-axis current i_{q,out}, the d-axis voltage v_{d,out} and the q-axis voltage v_{q,out}, and the frequency command value f_{ref} and the amplitude command value V_{ref} for the output voltage. The instantaneous current command calculation unit 25 makes instantaneous current command values i_{d,ref} and i_{q,ref} as current command values for the output current outputted to the power system.

That is, in the instantaneous current command calculation unit 25 of the present embodiment, not only the d-axis current i_{d,out} and the q-axis current i_{q,out} but also the d-axis voltage v_{d,out} and the q-axis voltage v_{q,out} are considered.

When the magnitude of each of the instantaneous current command values i_{d,ref} and i_{q,ref} exceeds an upper limit value, the instantaneous current command calculation unit 25 calculates an instantaneous current command value (corresponding to a “second current command value”) obtained by restricting the magnitude of each of the instantaneous current command values i_{d,ref} and i_{q,ref} to the upper limit value. The instantaneous current command calculation unit 25 makes the instantaneous current command value obtained by restricting the magnitude to the upper limit value as a current command value for the output current outputted to the power system 1.

When the magnitude of each of the instantaneous current command values i_{d,ref} and i_{q,ref} exceeds the upper limit value, the instantaneous current command calculation unit 25 decreases the upper limit value according to a time period having elapsed since the magnitude of each of the instantaneous current command values i_{d,ref} and i_{q,ref} exceeds the upper limit value.

The instantaneous current command calculation unit 25 includes a current command value output unit 25a and a restriction unit 25b. The current command value output unit 25a outputs the d-axis and q-axis current command values before restriction. The restriction unit 25b imposes restriction on the d-axis and q-axis current command values before restriction, and outputs the d-axis and q-axis current command values after restriction.

The current command value output unit 25a outputs a d-axis current command value i_{d,ref}* by adding, to the d-axis current i_{d,out}, a value according to a deviation between the amplitude command value V_{ref} and the d-axis voltage v_{d,out}.

The current command value output unit 25a further outputs a q-axis current command value i_{q,ref}* by adding a value according to the q-axis voltage v_{q,out} to the q-axis current i_{q,out}.

The d-axis and q-axis current command values outputted from the current command value output unit 25a to the restriction unit 25b is hereinafter referred to as “d-axis current command value and q-axis current command value before restriction.”

In the following detailed description of the current command value output unit 25a, the processing of outputting the d-axis current command value i_{d,ref}* before restriction will be described first, and thus, an adder 25c, a multiplier 25d, and an adder 25e will be described in this order.

The adder 25c outputs, to the multiplier 25d and a multiplication unit 25g, a value obtained by subtracting the d-axis voltage v_{d,out} that is an input from the dq transformation unit 24 from the voltage amplitude command value V_{ref} that is an input from the voltage amplitude command calculation unit 23.

The multiplier 25d outputs, to the adder 25e, a value obtained by multiplying the input from the adder 25c by an inverse of a gain K_{ACR}. Note that the output from the multiplier 25d is an example of a “value according to a difference between the amplitude command value V_{ref} and the d-axis voltage v_{d,out}.”

The adder 25e outputs, as the d-axis current command value i_{d,ref}* before restriction, a value obtained by adding the d-axis current i_{d,out} that is an input from the dq transformation unit 21 and the input from the multiplier 25d.

Next, the processing of outputting the q-axis current command value i_{d,ref}* before restriction will be described, and thus, a multiplier 25f, the multiplication unit 25g, an adder 25h, a multiplier 25i, and an adder 25j will be described in this order.

The multiplier 25f outputs, to the multiplication unit, a value obtained by multiplying the frequency command value f_{ref} that is an input from the frequency command calculation unit 22 by a gain K_{Ci}.

The multiplication unit 25g outputs, to the adder 25h, a value obtained by multiplying the input from the multiplier 25f by the input from the adder 25c described above.

The adder 25h outputs, to the adder 25j, a value obtained by adding the q-axis current i_{q,out} that is an input from the dq transformation unit 21 to the input from the multiplier 25d.

The multiplier 25i outputs, to the adder 25j, a value obtained by multiplying the q-axis voltage v_{q,out} that is an input from the dq transformation unit 24 by the inverse of the gain K_{ACR}. Note that the output from the multiplier 25i is an example of a “value according to the q-axis voltage v_{q,out}.”

The adder 25j outputs, as the q-axis current command value i_{q,ref}* before restriction, a value obtained by subtracting the input from the multiplier 25i from the input from the adder 25h.

The restriction unit 52b which will be described later outputs a d-axis current command value i_{d,ref} and a q-axis current command value i_{q,ref} obtained by restricting the d-axis current command value i_{d,ref}* and the q-axis current command value i_{q,ref}* that are outputted from the current command value output unit 25a, in order to suppress overcurrent.

Specifically, when magnitude A of a current command value obtained by vector-composition of the d-axis current command value i_{d,ref}* and the q-axis current command value i_{q,ref}* that are outputted from the current command value output unit 25a exceeds a predetermined upper limit value N, the restriction unit 25b outputs the d-axis current command value i_{d,ref} and the q-axis current command value i_{d,ref} obtained by reducing the d-axis current command value i_{d,ref}* and the q-axis current command value i_{q,ref}* at a ratio of a restriction coefficient N/A such that the magnitude A of the vector-composed current command value i_{ref}* becomes the upper limit value N. The restriction coefficient N/A can be a value obtained by dividing the upper limit value N by the magnitude A of the current command value.

The restriction unit 25b includes multiplication units 25k, 25l, 25s, and 25t, an adder 25m, an operation unit 25n, a detection unit 25o, a setting unit 25p, a division unit 25q, and a restriction unit 25r.

The multiplication unit 25k, the multiplication unit 25l, the adder 25m, and the operation unit 25n calculate magnitude A of a current command value i_{ref}* obtained by vector-composition of the d-axis current command value i_{d,ref}* and the q-axis current command value i_{q, ref}*.

The setting unit 25p sets an upper limit value NUM for magnitude DEN of the current command value i_{ref}*. The upper limit value N is required only to be, for example, a predetermined value equal to or less than, or equal to or greater than a rated current of the power converter 2. The setting unit 25p outputs the upper limit value NUM to the division unit 25q.

The division unit 25q outputs, to the restriction unit 25r, a division result NUM/DEN obtained by dividing the upper limit value NUM that is an input from the setting unit 25p by the magnitude DEN of the current command value i_{ref}*.

The restriction unit 25r outputs, to the multiplication units 25s and 25t, a restriction coefficient K_{I,LIM} that is a value obtained by restricting the division result NUM/DEN to a value between 0 (zero) and 1.

The magnitude DEN of the current command value i_{ref}* exceeding the upper limit value NUM means that the output current of the power converter 2 is in an overcurrent state.

The magnitude DEN of the current command value i_{ref}* not exceeding the upper limit value NUM means that the output current of the power converter 2 is not in an overcurrent state.

Note that the restriction coefficient K_{I,LIM} is an example of a “value indicating the degree of restriction.”

The multiplication units 25s and 25t output respectively, as the d-axis current command value i_{d,ref} and the q-axis current command value i_{q,ref} after restriction, values obtained by multiplying the d-axis current command value i_{d,ref}* and the q-axis current command value i_{q,ref}* before restriction by the restriction coefficient K_{I,LIM}.

### [Compensation Value Output Unit 26]

In the power converter 2, a frequency of the output voltage vₒᵤₜ is likely to deviate from the frequency fₙ of the power system when overcurrent occurs, thereby making it difficult to 1 maintain synchronization with the power system 1.

Here, the compensation value f_{ref,cmp} is a compensation value for preventing the frequency of the output voltage vₒᵤₜ from deviating from the frequency of the power system 1 when overcurrent occurs.

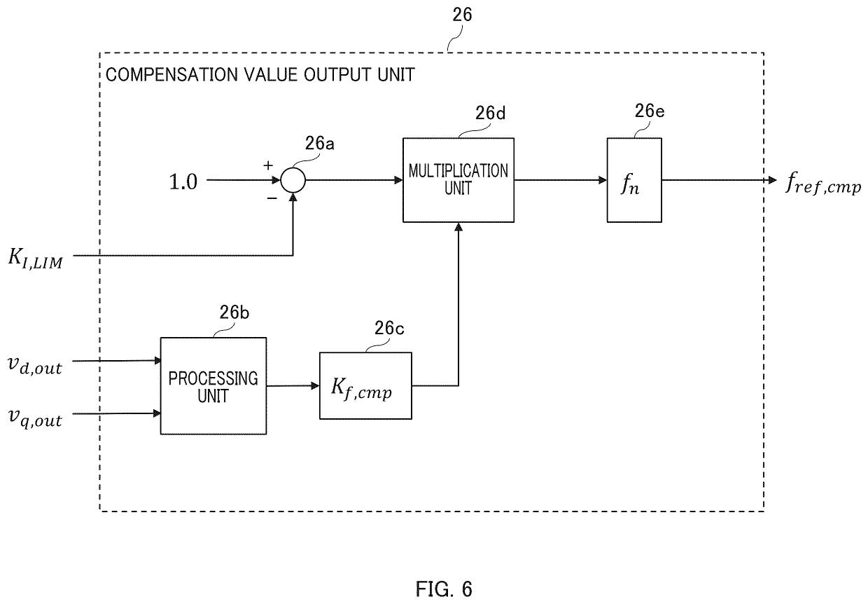

FIG. 6 is a diagram illustrating the compensation value output unit 26 of the power converter 2. The compensation value output unit 26 generates a frequency compensation value f_{ref,cmp} for compensating the frequency command value f_{ref} for the output voltage generated by the frequency command calculation unit 22, based on the output voltage vₒᵤₜ outputted to the power system 1. Specifically, when an absolute value DEN exceeds the upper limit value NUM, the compensation value output unit 26 outputs the compensation value f_{ref,cmp} for the frequency command value f_{ref}, based on the d-axis voltage v_{d,out} and the q-axis voltage v_{q,out}.

The compensation value f_{ref,cmp} is a value for making a difference between a frequency command value f_{ref2} after compensation and the rated frequency fₙ of the power system 1 smaller than a difference between a frequency command value f_{ref1} before compensation and the rated frequency fₙ.

The compensation value output unit 53 of the present embodiment outputs a compensation value that becomes closer to the frequency of the power system 1 as the degree of restriction increases, further based on a value indicating the degree of restriction.

Note that, in such an example, the “value indicating the degree of restriction” is the restriction coefficient K_{I,LIM}. The closer a value of the restriction coefficient K_{I,LIM} is to 0 (zero), the greater the compensation value f_{ref,cmp} becomes. The closer a value of the restriction coefficient K_{I,LIM} is to 1, the smaller the compensation value f_{ref,cmp} becomes.

The compensation value output unit 26 includes an adder 26a, a processing unit 26b, multipliers 26c and 26e, and a multiplication unit 26d.

The adder 26a outputs, to the multiplication unit 26d, a value obtained by subtracting the restriction coefficient K_{I,LIM} that is an input from the instantaneous current command calculation unit 25 from 1.

The processing unit 26b outputs an output voltage V_{q,out,err} after unification, based on the d-axis voltage v_{d,out} and the q-axis voltage v_{q,out} each that is an input from the dq transformation unit 51. The output voltage v_{q,out,err} after unification is represented by the following equation.

$${ν}_{q , out , err} ≡ \{ \begin{matrix}{v}_{q , out} & ( {v}_{d , out} > 0 ) \\ {v}_{q , out , tmp} & ( otherwise )\end{matrix} \qquad [ Math . 1 ]$$

Here, the voltage v_{q,out,tmp} is represented by the following equation.

$${ν}_{q , out , tmp} ≡ \{ \begin{matrix}- {v}_{q , out} + 2 {v}_{s , out} & ( {v}_{q , out} > 0 ) \\ - {v}_{q , out} - 2 {v}_{s , out} & ( otherwise )\end{matrix} \qquad [ Math . 2 ]$$

Here, the voltage v_{s,out} is represented by the following equation.

$${v}_{s , out} ≡ \sqrt{{v}_{d , out}^{2} + {v}_{q , out}^{2}} \qquad [ Math . 3 ]$$

The multiplier 26c outputs, to the multiplication unit 26d, a value obtained by multiplying the output voltage v_{q,out,err} that is an input from the processing unit 26b by a gain K_{f,cmp}.

The multiplication unit 26d outputs, to the multiplier 26e, a value obtained by adding the output from the adder 26a and the output from the multiplier 26c. The output from the multiplication unit 26d is a value obtained by normalizing the compensation value f_{ref,cmp} for the frequency command value by the rated frequency fₙ of the power system 1.

The multiplier 26e outputs a value obtained by multiplying the input from the multiplication unit 26d by the rated frequency fₙ of the power system 1. The output of the multiplier 26e is the compensation value f_{ref,cmp} for the frequency command value.

### [Inverse dq Transformation Unit 27]

The inverse dq transformation unit 27 of FIG. 2 performs inverse dq transformation on the d-axis current command value i_{d,ref} and the q-axis current command value i_{q,ref} that are each an input from the instantaneous current command calculation unit 25, and outputs a current command value i_{ref} for each phase.

### [Instantaneous Voltage Command Calculation Unit 28]

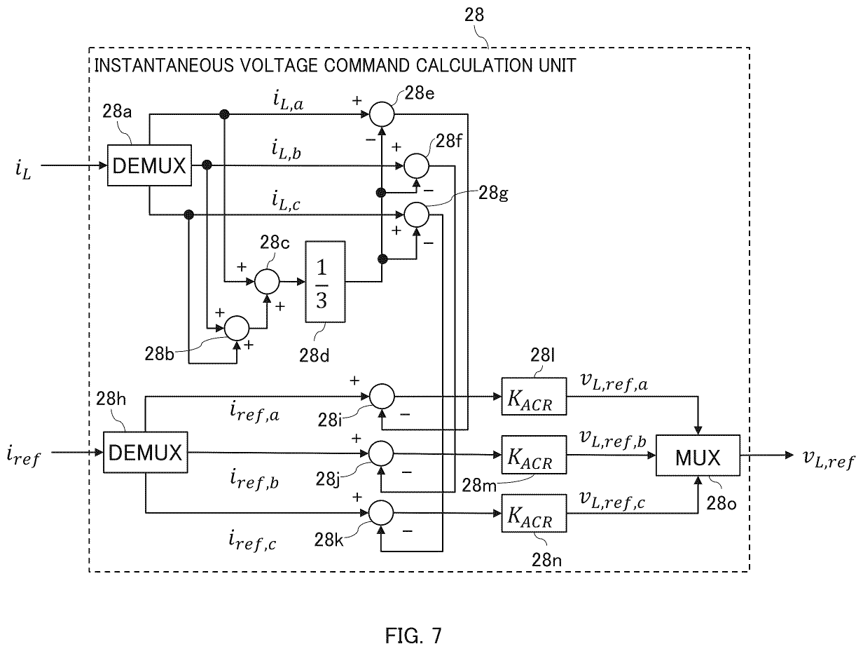

FIG. 7 is a diagram illustrating the instantaneous voltage command calculation unit 28 (corresponding to a “voltage command calculation unit”) of the power converter 2. The instantaneous voltage command calculation unit 28 generates a command value v_{L,ref} for the voltage outputted from the power conversion unit 31, based on a current command value i_{ref} for the output current, a filter current i_{L} having flowed in the filter 3, and the output voltage vₒᵤₜ outputted to the power system 1.

The instantaneous voltage command calculation unit 28 includes demultiplexers 28a and 28h, adders 28b, 28c, 28e, 28f, 28g, 28i, 28j, and 28k, multipliers 28d, 28l, 28m, and 28n, and a multiplexer 28o.

The demultiplexer 28a develops an instantaneous current i_{L} outputted from the power conversion unit 31 to three-phase instantaneous currents i_{L,a}, i_{L,b} and i_{L,c}.

The adder 28b and the adder 28c output, to the multiplier 28d, a value obtained by summing the instantaneous currents i_{L,b} and i_{L,c}.

The multiplier 28d outputs, to the adders 28e, 28f, and 28g, a value obtained by dividing the input value from the adder 28c by 3.

The adders 28e, 28f, and 28g respectively output, to the adders 28i, 28j, and 28k, values obtained by adding the inputs from the multipliers to the respective instantaneous currents i_{L,b} and i_{L,c}.

The demultiplexer 28h develops the instantaneous current command value i_{ref} that is an input from the inverse dq transformation unit 27 to three-phase instantaneous current command values i_{ref,a}, i_{ref,b}, and i_{ref,c}.

The adders 28i, 28j, and 28k respectively output, to the multipliers 28l, 28m, and 28n, values obtained by adding the inputs from the adders 28e, 28f, and 28g to the respective instantaneous current command values i_{ref,a}, i_{ref,b}, and i_{ref,c}.

The multipliers 28l, 28m, and 28n respectively output, to the multiplexer 28o, values obtained by multiplying the inputs from the adders 28l, 28j, and 28k by the gain K_{ACR}. The gain K_{ACR} is a parameter for performing a control so as to suppress a difference between the instantaneous current i_{L} and the instantaneous current command value i_{ref}.

Results v_{L,ref,a}, v_{L,ref,b}, and v_{L,ref,c} of operation by the multipliers 286l, 28m, and 28n are respective compensation values for three-phase instantaneous voltage command values.

The multiplexer 28o unifies, into one signal, the compensation values v_{L,ref,a}, v_{L,ref,b}, and v_{L,ref,c} for the three-phase instantaneous voltage command values that are inputs respectively from the multipliers 28l, 28m, and 28n, and outputs a compensation value v_{L,ref} for the instantaneous voltage command values.

### [Addition Unit 29]

The addition unit 29 (corresponding to a “first addition unit”) outputs, as a command value v_{PWM,ref} for the voltage outputted from the power converter 2, a value obtained by adding the output voltage vₒᵤₜ for each phase to the voltage command value v_{L,ref} for each phase that is an input from the instantaneous current command calculation unit 25.

### [PWM Pulse Generation Unit 30]

The PWM pulse generation unit 30 detects an intersection between a carrier wave realized by a triangular wave, for example, and a sine wave as a fundamental wave. Accordingly, the PWM pulse generation unit 30 determines a duty cycle of a PWM pulse and generates a PWM pulse signal v_{PWM} having the determined duty cycle.

The PWM pulse signal V_{PWM} is outputted to the power conversion unit 31 to drive an inverter circuit in the power conversion unit 31.

### [Power Conversion Unit 31]

The power conversion unit (power conversion circuit) 31 includes a direct-current power supply and an inverter circuit (not illustrated) including a plurality of switching elements. The inverter circuit converts a DC voltage from the direct-current power supply into an AC voltage, and outputs the AC voltage to the power system 1 via the filter 3.

At this time, the inverter circuit outputs a voltage generated based on the PWM pulse signal v_{PWM,ref} that is an output from the PWM pulse generation unit 30.

When the voltage based on the PWM pulse signal v_{PWM,ref} is outputted from the power conversion unit 31, a voltage vₒᵤₜ corresponding to the instantaneous voltage command value v_{out,ref} that is an output from the instantaneous voltage command calculation unit 28 is outputted to the node N (FIG. 2) from the power conversion unit 31.

Note that a combination of the PWM pulse generation unit 30 and the power conversion unit 31 corresponds to a “voltage output unit.” That is, the voltage output unit outputs, to the filter 3, an output voltage according to the result of the addition by the addition unit 55.

In the above-described power converter 2, when the instantaneous current command value i_{ref} is calculated, an instantaneous voltage vₒᵤₜ is considered. Specifically, the instantaneous current command value i_{ref} is restricted after being set to a value according to an instantaneous current iₒᵤₜ and an instantaneous voltage vₒᵤₜ (instantaneous current command value i_{ref}* before restriction). As a result, overcurrent can be suppressed.

### Second Embodiment

A power converter of the present embodiment differs from that of the first embodiment in the processing executed by the setting unit 25p (FIG. 5) of the instantaneous current command calculation unit 25 of the first embodiment. Assume that the upper limit value N set by the setting unit 52p of the first embodiment is set to a constant value with respect to time.

The setting unit of the present embodiment sets an upper limit value N(t) that decreases according to a time period having elapsed since an absolute value A exceeds a threshold value.

In particular, the setting unit of the present embodiment sets the upper limit value N(t) that changes in a stepwise manner according to a time period having elapsed since the absolute value exceeds the threshold value. An example of the use of the upper limit value N(t) of the present embodiment will be described using the after-mentioned simulation results.

==Modification==

A power converter according to the present modification differs from that of the second embodiment in the functional form of the upper limit value N(t). The second embodiment assumes that the upper limit value N(t) changes in a stepwise manner with respect to time t, but this is not limited to the above configuration.

The setting unit of the present modification sets the upper limit value N(t) that changes continuously according to a time period having elapsed since the time at which an absolute value A exceeds a threshold value. An example of the use of the upper limit value N(t) of the present embodiment will be described using the after-mentioned simulation results.

### ==Simulation Results==

Numerical simulation was performed on the power converters of the first embodiment, the second embodiment, and the modification. The simulation results will be described.

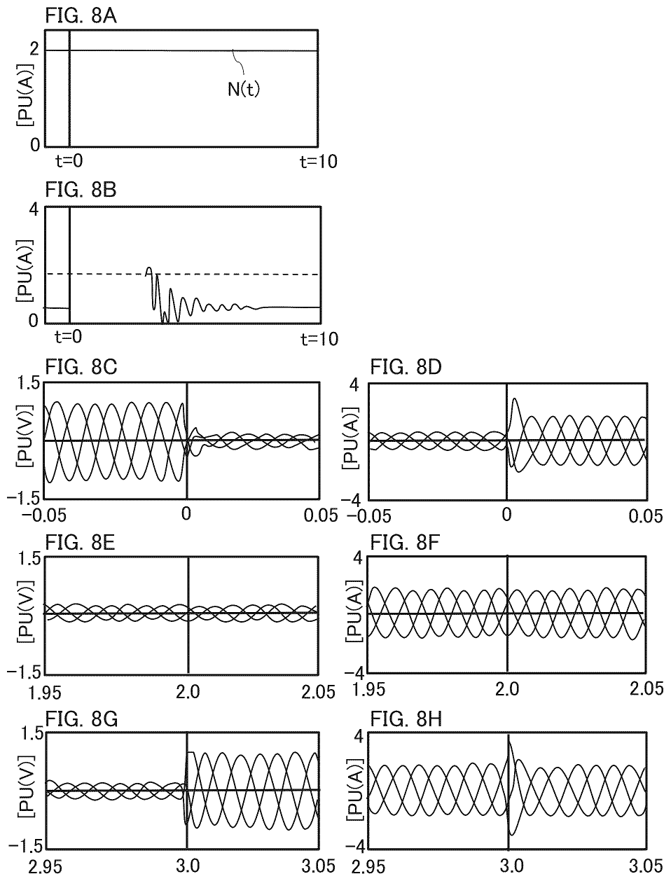

FIGS. 8, 9, and 10 are diagrams illustrating the simulation results for the respective power converters of the first embodiment, the second embodiment, and modification 1, respectively.

In these diagrams, (a) illustrates the upper limit value N(t). In (a), the horizontal axis corresponds to time t, and indicates t=−1 [sec] to 10 [sec].

This numerical simulation assumes that a three-phase short-circuit fault occurs in the power system 1 at time t=0 [sec].

In FIG. 8 illustrating the result of the first embodiment, the upper limit value N(t) is 1.7 [PU], and is constant regardless of time.

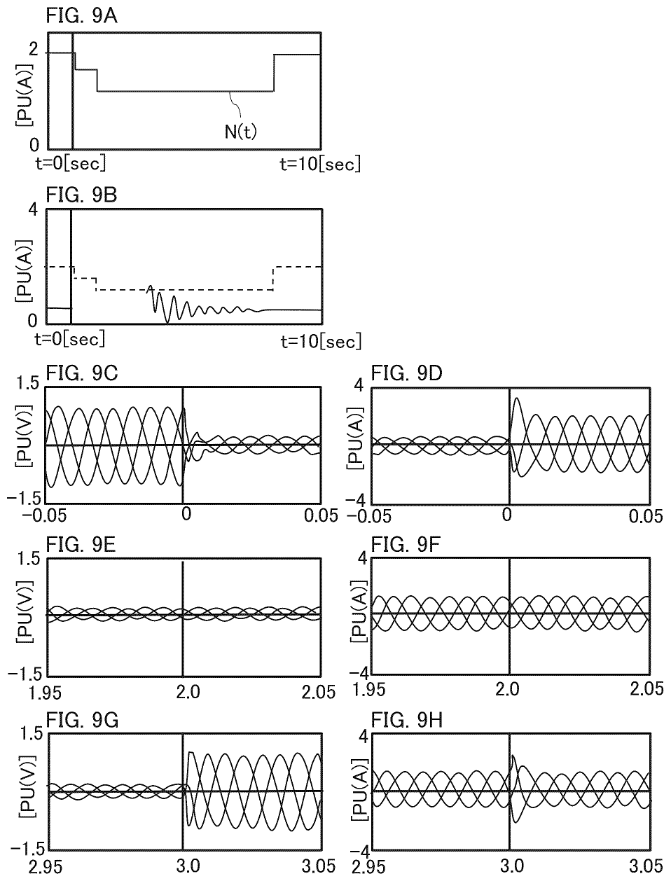

In FIG. 9 illustrating the result of the second embodiment, the upper limit value N(t) changes in a stepwise manner. Specifically, N(t)=2.0 [PU] refers to a time period from before the occurrence of the fault (t<0) to t=0.1 [sec] immediately after the occurrence of the fault. N(t)=1.7 [PU] refers to a time period from t=0.1 [sec] to t=1.0 [sec]. N(t)=1.2 [PU] refers to a time period from t=1.0 [sec] to t=5.0 [sec]. N(t)=2.0 [PU] refers to a time period after t=5.0 [sec].

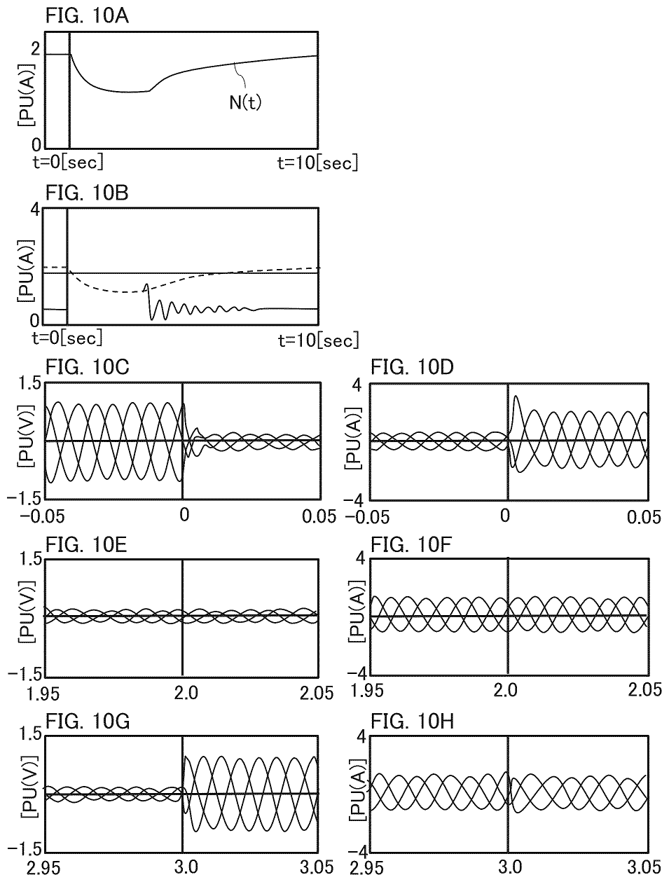

In FIG. 10 illustrating the result of the modification, the upper limit value N(t) changes continuously. Specifically, N(t)=2.0 [PU] refers to a time period from before the occurrence of the fault (t<0) to t=0.0 [sec] when the fault occurs. N(t) decreases to N(t)=1.2 [PU] after t=0 [sec] according to a primary delay with time constant τ=0.5 [sec]. After that, N(t) increases to N(t)=2.0 [PU] according to a primary delay with time constant τ=2.0 [sec].

In each of FIGS. 8 and 9, (b) illustrates an outputted apparent current. In (b), the horizontal axis corresponds to time t, which is the same as (a).

In these diagrams, (c) and (d) each illustrate simulation results in the vicinity of t=0 [sec] (the horizontal axis corresponds to t=−0.05 [sec] to 0.05 [sec]).

Here, (c) illustrates waveforms of each of three-phase output voltages. The vertical axis indicates −1.5 [PU] to 1.5 [PU]. Here, (d) illustrates waveforms of each of three-phase output currents. The vertical axis indicates −4 [PU] to 4 [PU].

In these diagrams, (e) and (f) each illustrate simulation results in the vicinity of t=2 [sec] (the horizontal axis corresponds to t=−1.95 [sec] to 2.05 [sec]). The vertical axes of (e) and (f) are the same as those of (c) and (d), respectively.

In these diagrams, (g) and (h) each illustrate simulation results in the vicinity of t=3 [sec] (the horizontal axis corresponds to t=−2.95 [sec] to 3.05 [sec]). The vertical axes of (g) and (h) are the same as those of (c) and (d), respectively.

Next, each of the results will be observed. First, in the vicinity of time t=0 ((c) and (d) in FIGS. 8 and 9) at which the fault is assumed to occur, the output current temporarily increases to about three times the rated current in both of the cases, and varies at about twice the rated current in a time period until t=0.05 [sec] ((d) in these diagrams).

On the other hand, in the vicinity of t=2.0 ((e) and (f) in these diagrams), the output current varies at about 1.7 times the rated current in the case (FIG. 8) of the first embodiment (FIG. 8(f)). The output current varies at about the rated current ((f) in FIGS. 9 and 10) in the cases of the second embodiment and modification 1 (FIGS. 9 and 10).

Also in the vicinity of t=3.0 ((g) and (h) in these diagrams), the output current varies at about 1.7 times the rated current in the case (FIG. 8) of the first embodiment (FIG. 8(h)). The output current varies at about the rated current ((h) in FIGS. 9 and 10) in the cases of the second embodiment and modification 1 (FIGS. 9 and 10).

These results show that, in the power converters of the second embodiment and the modification (FIGS. 9 and 10), the current exceeding the rated current is temporarily outputted immediately after the occurrence of the fault, but quickly returns to a current value within the rated current thereafter.

That is, immediately after the occurrence of the fault, the current exceeding the rated current is outputted, thereby contributing to stabilization of the power system. After the current exceeding the rated current is outputted, the current quickly returns to the current within the rated current, thereby allowing operation of the power converter to be continued.

Accordingly, the upper limit value N(t) is set so as to decrease according to a time period having elapsed since the occurrence of the fault, thereby contributing to stabilization of the power system and allowing operation of the power converter to be continued.

### ==Third Embodiment==

A power converter of the present embodiment differs from that of the first embodiment in the processing executed by the setting unit 25p (FIG. 5) of the instantaneous current command calculation unit 25 of the first embodiment. Assume that the upper limit value N set by the setting unit 25p of the first embodiment is a constant value with respect to time.

When an absolute value A exceeds a predetermined threshold value, a setting unit of the present embodiment sets an upper limit value N(T) to be lower as a temperature T of the power converter increases.

Accordingly, overcurrent can be supplied within a range of a thermal limit of the power conversion unit 31. Thus, it is possible to prevent the power conversion unit 31 from breaking down or being suspended due to an influence of heat.

### ==Effects of Embodiment==

The power converter 2 of the above-described embodiments is a power converter that is interconnected with a power system 1 to operate as a virtual synchronous generator. The power converter including: a power conversion unit 31; a filter 3 provided between the power system 1 and the power conversion unit 31; and a control device 20 configured to control a voltage outputted from the power conversion unit 31, wherein the control device 20 includes: a voltage amplitude command calculation unit 23 configured to calculate an amplitude command value for an output voltage outputted to the power system 1; a frequency command calculation unit 22 configured to calculate a first frequency command value based on a rated frequency of the power system to make the first frequency command value as a frequency command value for the output voltage outputted to the power system; a current command calculation unit 25 configured to calculate a first current command value based on the amplitude command value for the output voltage, the frequency command value for the output voltage, and the output voltage and an output current outputted to the power system 1 to make the first current command value as a current command value for the output current outputted to the power system 1; and an instantaneous voltage command calculation unit 28 configured to generate a command value for the voltage outputted from the power conversion unit, based on the current command value for the output current, a filter current having flowed in the filter unit, and the output voltage outputted to the power system. When magnitude of the first current command value exceeds an upper limit value, the current command calculation unit 25 calculates a second current command value obtained by restricting the magnitude of the first current command value to the upper limit value to make the second current command value as the current command value for the output current outputted to the power system 1.

According to such a configuration, an instantaneous voltage is considered when an instantaneous current command value is calculated, which can suppress overcurrent.

In the power converter 2 of the embodiment, when the magnitude of the first current command value exceeds the upper limit value, the current command calculation unit 25 decreases the upper limit value according to a time period having elapsed since the magnitude of the first current command value exceeds the upper limit value. According to such a configuration, overcurrent is not rapidly suppressed immediately after an absolute value A exceeds a threshold due to occurrence of breakdown of the power system 1 or the like. Immediately after the occurrence of the failure in the power system 1 or the like, the current larger than that in a normal state is supplied, which can contribute to stabilization of the power system 1.

In the power converter 2 of the embodiment, when the magnitude of the first current command value exceeds the upper limit value, the current command calculation unit 25 changes the upper limit value in a stepwise manner according to the time period having elapsed since the magnitude of the first current command value exceeds the upper limit value. According to such a configuration, it is possible to supply a larger current to the power system 1 for a predetermined time period having elapsed since the occurrence of the failure or the like, and to supply the current within a reasonable range for the power conversion unit 31 to the power system 1 thereafter. Thus, it is possible to contribute to stabilization of the power system 1 while suppressing a cost of the power conversion unit 31.

In the power converter 2 of the embodiment, when the magnitude of the first current command value exceeds the upper limit value, the current command calculation unit 25 continuously changes the upper limit value according to the time period having elapsed since the magnitude of the first current command value exceeds the upper limit value. According to such a configuration, it is possible to perform a control so as to continuously and more naturally reduce overcurrent. It is possible to realize safer operation with consideration of cooling of the power conversion unit 31.

In the power converter 2 of the embodiment, when the magnitude of the first current command value exceeds the upper limit value, the current command calculation unit 25 sets the upper limit value to be lower as a temperature of the power conversion unit 31 increases. According to such a configuration, in the case where a temperature of a component requiring thermal consideration increases, lowering of the upper limit value can supply overcurrent within a range of a thermal limit of the power conversion unit 31. As a result, it is possible to prevent the power conversion unit 31 from breaking down or being suspended due to an influence of heat. Both of them are possible.

The power converter 2 of the embodiment, further including a compensation value output unit 26 configured to generate a frequency compensation value for compensating the first frequency command value for the output voltage generated by the frequency command calculation unit 22, based on the output voltage outputted to the power system 1, wherein the frequency command calculation unit generates a second frequency command value based on the first frequency command value and the frequency compensation value to make the second frequency command value as the frequency command value. According to such a configuration, synchronization with the power system 1 can be maintained when the overcurrent is suppressed due to the occurrence of failure in the power system 1 or the like. That is, it is possible to continue to operate while suppressing overcurrent.

In the power converter of the embodiment, the current command calculation unit 25 further outputs a value indicating a degree of restriction to the magnitude of the first current command value. The compensation value output unit 26 generates the frequency compensation value such that the second frequency command value becomes closer to the frequency of the power system than the first frequency command value as the value indicating the degree of restriction increases. A frequency command value according to a scale of the failure or the like can be calculated. As a result, accuracy of the frequency command value is improved, which can suppress destabilization of the power system 1.

1. A power converter that is interconnected with a power system to operate as a virtual synchronous generator, the power converter comprising:
a power conversion circuit;
a filter provided between the power system and the power conversion circuit; and
a control device configured to control an output voltage outputted from the power conversion circuit to the power system, the control device including:
a voltage amplitude command calculation unit configured to calculate an amplitude command value for the output voltage;
a frequency command calculation unit configured to calculate a first frequency command value, based on a rated frequency of the power system, and to set the first frequency command value as a frequency command value for the output voltage;
a current command calculation unit configured to calculate a first current command value, based on the amplitude command value for the output voltage, the frequency command value for the output voltage, the output voltage, and an output current that is outputted to the power system, and to set the first current command value as a current command value for the output current; and
a voltage command calculation unit configured to generate a command value for the output voltage, based on the current command value for the output current, a filter current having flowed in the filter, and the output voltage,
wherein
the current command calculation unit is configured to, responsive to a magnitude of the first current command value exceeding an upper limit value, calculate a second current command value by restricting the magnitude of the first current command value to the upper limit value, and to set the second current command value as the current command value for the output current.

2. The power converter according to claim 1, wherein
the current command calculation unit is configured to, responsive to the magnitude of the first current command value exceeding the upper limit value, decrease the upper limit value according to a time period having elapsed since the magnitude of the first current command value exceeds the upper limit value.

3. The power converter according to claim 2, wherein
the current command calculation unit decreases the upper limit value in a stepwise manner.

4. The power converter according to claim 2, wherein
the current command calculation unit decreases the upper limit value continuously.

5. The power converter according to claim 1, wherein
the current command calculation unit is configured to, when the magnitude of the first current command value exceeds the upper limit value, set the upper limit value to have a decreased value as a temperature of the power conversion circuit increases.

6. The power converter according to claim 1, wherein
the control device further includes a compensation value output unit that is configured to generate a frequency compensation value for compensating the first frequency command value for the output voltage generated by the frequency command calculation unit, based on the output voltage, and
the frequency command calculation unit is configured to generate a second frequency command value based on the first frequency command value and the frequency compensation value, and to set the second frequency command value as the frequency command value.

7. The power converter according to claim 6, wherein
the current command calculation unit is configured to further output a value indicating a degree of restriction to the magnitude of the first current command value, and
the compensation value output unit is configured to generate the frequency compensation value such that the second frequency command value becomes closer to the frequency of the power system than the first frequency command value as the value indicating the degree of restriction increases.
